(19) United States
(12) Patent Application Publication
(10) Pub. No.: US 2008/0250082 A1
(43) Pub. Date: Oct. 9, 2008

(54) Method of Backing Up and Restoring Data in a Computing Device

(75) Inventor: Corinne Dive-Reclus, Hertfordshire (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: SYMBIAN SOFTWARE LIMITED, London (GB)

(21) Appl. No.: 11/568,372

(22) PCT Filed: Apr. 29, 2005
(86) PCT No.: PCT/GB2005/001659

§ 371 Date: Oct. 26, 2006

(30) Foreign Application Priority Data
Apr. 29, 2004 (GB) 0409636.8

(51) Int. Cl. G06F 17/30

(52) U.S. Cl. 707/204; 707/E17.005

(57) ABSTRACT

Installable files installed on a first computing device are backed up to a second computing device and restored from the second device to the first device and/or a further device using the same means to verify the integrity of the files as used for the original installation of the files on the first device.

This invention relates to a method of backing up and restoring data to a computing device, and in particular to a secure method for backing up and restoring data to a mobile computing device used for storing sensitive personal data.

The term computing device as used herein is to be expansively construed to cover any form of electrical device and includes, data recording devices, such as digital still and movie cameras of any form factor, computers of any type or form, including hand held and personal computers, and communication devices of any form factor, including mobile or wireless phones, smart phones, communicators which combine communications, image recording and/or playback, and computing functionality within a single device, and other forms of wireless and wired information devices.

The use of mobile devices to store data has been increasing since the early 1990s, and in particular with the advent of personal digital assistants (PDAs). Because PDA devices are small and convenient to carry on a person, there is an increasing trend for users to depend on the organiser functionality provided in such devices. The storage of at least one duplicate copy of important personal data has, in tandem, also become very commonplace in order to minimise the disruption caused by loss of or damage to the primary data stored on the mobile device itself. Early providers of the PDA, such as Psion™ in Europe and Palm™ in the USA, pioneered connectivity solutions that copied the data on mobile devices to the hard disks on standard home or office PCs via RS232 serial cables. While serial links have now largely been replaced by faster and more convenient connections such as infra-red, Bluetooth and Universal Systems Bus (USB), the principle of copying data from the more easily lost or damageable mobile devices to the fixed devices that are perceived as being more secure and permanent is now an established technique with the majority of users of mobile devices, including virtually all wireless telephones that include organiser functionality. These latter devices are now increasingly known as smart phones.

There are two main types of data copying in common use. Files can be copied from the mobile device to another computer (typically a PC) in their entirety; this is a straightforward backup mechanism. Should anything happen either to the data on the mobile device or to the mobile device itself, the files can be reinstated by copying back from the PC, either to the mobile device they originated from or to a compatible device, in a complementary restore operation.

The second type of data copy is a synchronisation operation between the mobile device and another device. This is mostly used for personal data held in applications such as ‘contacts’ or ‘agenda’ on the mobile device. This type of data copy or synchronisation acts on entry-level personal data held in the applications rather than on the entire application file, and reads the relevant data from files used by the application on the mobile device and writes this data into the files used by the corresponding application on the other device. Synchronisation operations can run in either direction or in both directions at the same time.

Backup and restore operations are most useful for static data that changes relatively infrequently, and also where there is little or no requirement to use the data off the device. There is an increasing amount of such data; for example, program files for add-on applications, and media content such as music. Synchronisation, in contrast, is more useful in situations where the data set or the content is relatively fluid and does change on a frequent basis, and where there is a requirement to access the data off the device.

The problem domain with which this invention is particularly concerned is that of the backup and restore of static data from and to a mobile device. Standard methods of backup and restore have significant security problems arising from the requirement that the backup should not be kept on the original device itself but on some other medium in a separate location (typically a disk or other non-volatile memory medium on a PC). Two threats to the security of the data are particularly apparent:
1) Program files that are backed up from a mobile device to (for example) a PC are vulnerable to tampering while they are off the mobile device by malicious programs. Such tampering could destabilise the mobile device platform, or be used to spend the user's money or do a wide variety of other undesirable things if the tampered files were ever restored onto the mobile device and the tampered code executed. This threat can perhaps be considered fairly small since it requires a backup, an infection, a restore and a subsequent execution all to occur in the right order. However, the possibilities it promotes for disruption or for theft nevertheless remain significant.
2) Backup followed by unauthorized modification followed by a restore could conceivably be used as an unauthorised way to circumvent or remove restrictions on program files which prevent protected digital rights management (DRM) content, such as music or video files, from being accessed, played, viewed or redistributed. Unlike the first threat, which is from an unknown source and to the user of a device, this second threat is from the user of the device, and is of specific concern to providers and distributors of protected content.

In order to restore from backup safely and securely, without compromising either the security and integrity of the device being restored to, or of the data being restored, reliable assurances must be provided:
a) that the data which has been backed up has not been tampered with, either by the user or by any third party; and
b) that the data is being restored by someone who has the right to do so, and that digital property is not being stolen or procured without authority.

File encryption technology is insufficient to secure static data content against these threats because it does not prevent threats which come from the owner of the device. Furthermore, the mechanisms for carrying out the necessary authentication checks need to be implemented on the device itself as well as in the backup file. Hence, no current backup and restore technologies are considered to provide the necessary assurances for the static data.

Therefore, it is an object of the present invention to provide an improved method for backing up data in a secure manner in a computing device.

A key element of this invention lies in the perception that, with respect to static data, to backup and restore data in a secure manner presents precisely the same authentication and verification problems as does secure installation of program or application software. The same concerns apply in both cases:
How to ensure that an archive (whether a backup archive or an install archive) is genuine?
How to ensure that an archive has not been tampered with?
How to ensure that someone seeking to extract the archive contents has authority to do so?

Thus, to use the same security, authentication and verification mechanisms for backup and restore of files or data as are used for the original install can provide significant and surprising benefits.

According to a first aspect of the present invention there is provided a method of backing up one or more installable files installed on a first computing device to a second computing device which enables one or more files backed up from the first device to the second device to be restored from the second device to the first device and/or a further device using the same means to verify the integrity of the one or more restored files as used for the installation of the one or more files on the first device.

According to a second aspect of the present invention there is provided a computing device arranged to operate in accordance with a method of the first aspect.

According to a third aspect of the present invention there is provided an operating system for a computing device arranged to cause the computing device to operate in accordance with a method according to the first aspect.

An embodiment of the present invention will now be described, by way of further example only, with reference to the accompanying drawings in which:—

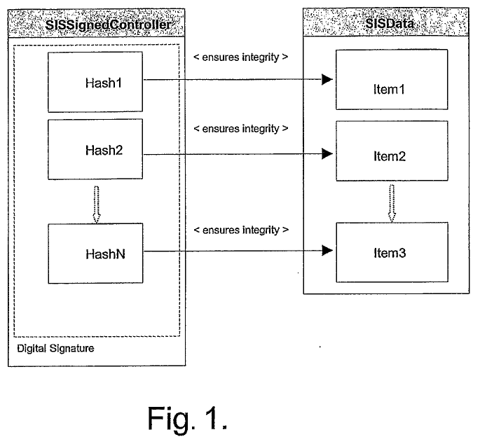

FIG. 1 illustrates a file installation verification process as used in the Symbian OS™ operating system; and

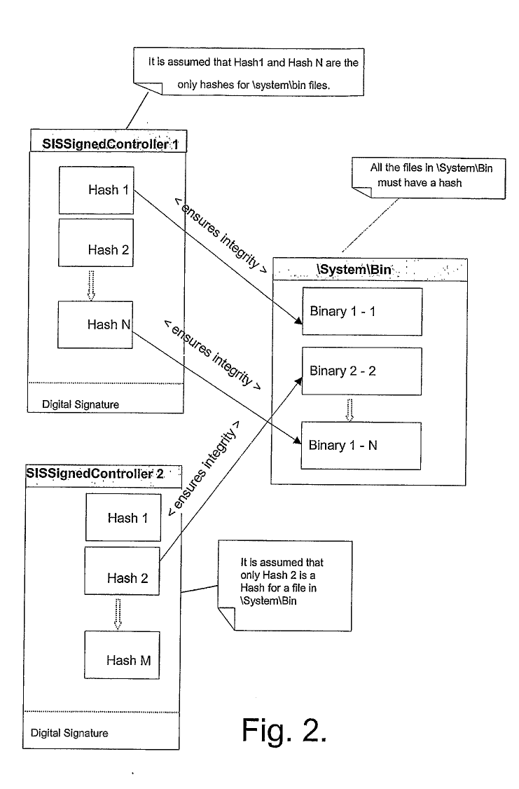

FIG. 2 illustrates how executables are protected against tampering by a software installer program in the Symbian OS™ operating system.

An embodiment of the present is described below with reference to an implementation developed for use in the Symbian OS™ operating system available from Symbian Limited of London, England, principally, but not exclusively, for use in mobile communications devices in the form of smart phones. It should however be readily appreciated by those skilled in the art that the present invention may also be applied in other types of operating systems and devices where it is required to provide for a secure software backup and restore procedure.

The following description of the backup and restore mechanism of the present invention focuses on protected content and executable program files and applications. However, it should also be appreciated that the secure backup and restore mechanism can be used for other file types. Especially, the invention may be used to particular advantage for files that have been installed originally via a file format known in the Symbian OS™ operating system as SIS.

Because the present invention is predicated on the basis of using the same means for verifying the integrity of back up files as was used for original installation of the files, the present invention will be described with reference to the Symbian SIS file format. In this file format, a software installation package in the form of SIS files is used to package any number or types of executable files for installation on a computing device running the Symbian OS™ operating system.

The SIS file of this operating system consists of two main parts:
1. A SISSignedController part, which contains the metadata needed to control file installation on the device. This part of the SIS file is digitally signed using a standard certificate conforming to the X.509 v.3 public key infrastructure (PKI), which is verifiable and can therefore be used to authenticate the integrity of the metadata.
2. An SIS Data part, which contains the actual data files that are to be installed on the device.

Current smart phone devices are configured to contain root certificates, which are stored in the read only memory (ROM) of the device. At installation time, the digital signature of the SISSignedController part is verified against one of the root certificates in the device ROM, and the integrity of this signature can therefore be assured. Although the SISData part of the installation file is not itself digitally signed in a similar fashion, for each of the files that are in the SISData part there is a corresponding hash in the SISSignedController. Since these hashes are contained in the signed and verified SISSignedController part of the installation file, verification of each hash guarantees the integrity of each of the files in the SISData part of the installation file. This verification process is shown in FIG. 1.

When installing a new SIS file, the SISSignedController part is stored on the device along with the files in the SISData part of the SIS file. Preferably, to further improve security, the SISSignedController part is stored in a protected location of the device memory. This means that for each file a user installs on the device, there is a respective hash in the SISSignedController part.

With the present invention, when a backup routine is performed for installed files, any SISSignedController stored on the device is also backed up. No special measures need to be taken to ensure the integrity of the SISSignedControllers when backed up off the original device because their digital signatures already guarantee that tampering can be detected. Once the SISSignedControllers are backed up, all the installed files that they reference can also be backed up, and since the hashes of these installed files are held securely in the SISSignedControllers, the integrity of the backed up files upon restoring onto the original device, or another device, can also be guaranteed, since any tampering with the installed files whilst backed up off the original device will be clearly evident.

When restoring the installed files, the SISSignedController parts are first restored to the device onto which it is required to reinstall the installed files (the restore device). The integrity of any SISSignedController part is verified by means of the respective digital signatures, which are traceable back to the root certificates in the device ROM. The requirement that the root certificates present on the restore device are the same as those on the original device is the main constraint on a successful restore because, should any root certificate for a SISSignedController not be present on the restore device, it would need to be retrieved before a restore would be permitted onto that device. The exact mechanism for retrieving root certificates is not material to this invention and would be apparent to a person skilled in this art. This mechanism will not therefore be described in the context of the present application.

If one of the required root certificates has been revoked for any reason, then it will not be possible to retrieve and the restore will abort in accordance with standard PKI practice. It can be seen from the above description that the above checks are the same as those carried out when the SIS file is originally installed so they provide a level of security at least equal to the original install. If the signature for the SISSignedController cannot be verified successfully, it is not restored.

Once the SISSignedController itself is restored, the restore process can then proceed to verify the integrity of each of the installed files referenced in the SISSignedController by comparing the respective hashes of these files with the hashes contained in the SISSignedController. Hence, it can be seen that for each installed file restored in this way, the check to verify integrity is the same as followed for the original installation, so it provides the same level of security. If a hash for a installed file to be restored does not match with that in the restored SISSignedController, or if a hash for a file cannot be found in any of the SISSignedControllers, not only the file in question, but also the remainder of the file package of which it may be a part, will fail to be restored. This is to ensure that the restore device is left in a consistent and stable state notwithstanding the attempted restore procedure.

The mechanism of matching hashes of files with the hashes in the SISSignedController can only be performed for read-only files. If the installed file can legitimately be updated after installation, then it follows that the hash for the file in question can be different. It should be noted that where a device manufacturer or distributor wishes to ship devices for sale with software or protected content preinstalled, it must always be ensured that the controller part of the file installation package is shipped with the device, otherwise the secure backup and restore of files in accordance with the present invention will not be possible.

FIG. 2 shows how installed files (executables), which in the example illustrated are stored in the \system\bin directory, are protected by the SISSignedControllers against tampering.

It can be appreciated, therefore, that backup of any files that include protection mechanisms as described above will always ensure that the protection mechanisms for such files will be backed up and restored, and will further ensure that any tampering with those protection mechanisms during the period when the protected files are stored off the original device will be detected, and will also prevent the restore operation from working.

The present invention is considered therefore to provide the following exemplary very significant advantages over known backup and restore procedures:
Any improvement in the ability to backup up and restore in a very secure manner executables that might access protected content but which protects both an owner's investment in that content and also the rights of the author of that executable, serves to increase confidence in the market for such executables. Hence, if for example the executable is one which permits the owner to conduct transactions with other parties, such as financial transactions, the volume of such transactions is likely to increase.
It is well known that as the complexity of an operating system increases, so does its unpredictability. For computing systems, including mobile phones, this can give rise to longer development times, decreased reliability, and less usable human-device interfaces. Since this invention posits that the same mechanism for assuring the security of software installations could also be used for assuring the security of backups made of static data, the complexity of the computing system overall is thereby decreased, with consequent reliability, usability and delivery benefits.
Using the same mechanisms for both install and backup of files reduces the memory requirements for the operating software of the device, which for mobile devices in particular is a considerable benefit because these devices are typically resource constrained in this area.
Apart from the presence of a root certificate which is in the tamperproof ROM of the device, this secure backup and restore mechanism does not rely on any authentication information or other metadata being present on the device to which a file is being restored: there is, for example, no dependency on separate stored registry information. This means that there is nothing to inhibit a restore to a new device, which is a considerable advantage for the relatively fragile mobile wireless devices for which total file loss from theft or damage is one of the most common threats, because relying on metadata already present would prevent a restore to a new device.
Because the invention uses the same mechanism for backup and restore as for installation, it provides a way to check that any application file securely restored from a backup device to a different restore device (in circumstances where the original device is stolen or irreparably damaged) is compatible with the restore device. This is because information regarding compatible devices may be included in the metadata of the SISSignedController, and this compatibility information can be used at restoration time to make sure that only applications compatible with the restore device are actually restored to that device.

In the method of the present invention the backup device is a mobile telephone, smartcard, memory device, PDA, laptop or desktop or any other type of computing device.

Communication between the original device, the backup device, and/or the device or devices onto which the files are reinstalled may be conducted over a wireless and/or a wired network.

Although the present invention has been described with reference to particular embodiments, it will be appreciated that modifications may be effected whilst remaining within the scope of the present invention as defined by the appended claims. For example, the metadata is described as being restored onto either the original device or another device after backup. However, the metadata may also be retained on the backup device, or may be discarded from the backup device after the reinstallation of the data files

1. A method of backing up one or more installable files installed on a first computing device to a second computing device which enables one or more files backed up from the first device to the second device to be restored from the second device to the first device and/or a further device using the same means to verify the integrity of the one or more restored files as used for the installation of the one or more files on the first device.

2. A method according to claim 1 wherein stored metadata is used to verify the integrity of the one or more installable files.

3. A method according to claim 2 wherein the metadata is signed with a digital certificate for enabling verification of the integrity of the metadata.

4. A method according to claim 3 wherein the digital certificate comprises an X.509 certificate.

5. A method according to claim 3 wherein the digital certificate of the metadata is verified by comparison with a root certificate stored in Read Only Memory (ROM) of the first device.

6. A method according to claim 2 to wherein the metadata and the one or more installable files comprise a single installation package.

7. A method according to claim 2 to wherein the metadata and the one or more installable files comprise separate installation packages.

8. A method according to claim 2 to wherein the metadata is stored on the first device and is backed up to the second device with the one or more installable files.

9. A method according to claim 2 to wherein the metadata comprises a respective hash for each of the one or more installable files.

10. A method according to claim 2 to wherein the metadata is restored to the first device or the further device with the one or more installable files.

11. A method according to claim 21, wherein the digital certificate of the metadata is verified when restored to the first device.

12. A method according to claim 2 to wherein the metadata is arranged to contain information for confirming the compatibility of the further device with the restored files.

13. A method according to claim 1 wherein the one or more installable files comprise executables such as programme files or dynamic link libraries.

14. A method according to claim 1 wherein the one or more installable files comprise protected content such as DRM media files or any other protected files.

15. A method according to claim 1 wherein the first device is a mobile telephone or PDA or laptop or desktop or any other type of computing device.

16. A method according claim 1 wherein the second device is a mobile telephone or smartcard or memory device or PDA or laptop or desktop or any other type of computing device.

17. A method according claim 1 wherein communication between the first, second and/or further devices is over a wireless network.

18. A method according to claim 1 wherein communication between the first, second and/or further devices is over a wired network.

19. A computing device arranged to operate in accordance with a method as claimed in claim 1.

20. An operating system for a computing device arranged to cause the computing device to operate in accordance with a method as claimed in claim 1.

21. A method according to claim 5 wherein the metadata is restored to the first device or the further device with one or more installable files.
